(19) United States
(12) Patent Application Publication
(10) Pub. No.: US 2024/0359535 A1
(43) Pub. Date: Oct. 31, 2024

(54) Toggle Structure of Vehicle Air Conditioning Vent

(71) Applicant: Illinois Tool Works Inc., Glenview, IL (US)

(72) Inventors: Yaoxian SHI, Shanghai (CN); Jie YU, Shanghai (CN)

(21) Appl. No.: 18/647,023

(22) Filed: Apr. 26, 2024

(30) Foreign Application Priority Data
Apr. 28, 2023 (CN) 202310484941.6
Apr. 19, 2024 (CN) 202410479427.8

(51) Int. Cl. B60H 1/34

(52) U.S. Cl. CPC B60H 1/3421

(57) ABSTRACT

The present disclosure relates to the technical field of vehicle parts, in particular to a toggle structure of a vehicle air conditioning vent. The toggle structure includes: an air outlet front blade including a first vane portion and a second vane portion; and a toggle assembly including a toggle bracket and a toggle, wherein the toggle bracket is configured to be mounted in a cavity between the first vane portion and the second vane portion, and the toggle button extends out of the joint portion of the first vane portion and the second vane portion. The toggle structure of the present disclosure can be suitable for longer and thicker air outlet blades, and has a suspended visual effect, so that the appearance of the vent is more attractive.

### RELATED APPLICATIONS

The present application claims the benefit of Chinese Patent Application Nos. 202310484941.6, filed Apr. 28, 2023, and 202410479427.8, filed Apr. 19, 2024, each titled “Toggle Structure of Vehicle Air Conditioning Vent,” the contents of which are hereby incorporated by reference.

### TECHNICAL FIELD

The present disclosure relates to the technical field of vehicle parts, in particular to a toggle structure of a vehicle air conditioning vent.

### BACKGROUND

In order to adjust the internal temperature of a vehicle, air conditioning vents are generally arranged on a dashboard or an auxiliary dashboard of the vehicle. The air conditioning vents should not only output air, but also being capable of adjusting the airflow direction and airflow volume and opening or closing an air duct. Generally, the vent includes a front blade and a rear blade. The front blade is used to adjust the airflow direction in up and down directions, and the rear blade is used to adjust the airflow direction in left and right directions. A toggle structure is generally arranged on the outer side of the front blade. The toggle structure can be toggled up and down to drive the front blade to rotate up and down so as to adjust the airflow direction of the vent in the up and down directions, and can also be toggled left and right to drive the rear blade to rotate left and right so as to adjust the airflow direction of the vent in the left and right directions.

### SUMMARY OF THE DISCLOSURE

The present disclosure relates generally to a vehicle air conditioning vent assembly, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 is a structural schematic diagram of a vehicle air conditioning vent assembly 100 according to an embodiment of the present disclosure.

FIG. 2 is an exploded schematic diagram of the vehicle air conditioning vent assembly 100 shown in FIG. 1.

FIG. 3 is a structural schematic diagram of the assembled toggle assembly 104 shown in FIG. 2.

FIG. 4 is a structural exploded schematic diagram of the toggle assembly 104 shown in FIG. 3.

FIGS. 5A and 5B are a structural schematic side view and a structural schematic rear view, respectively, of a toggle bracket 107 shown in FIG. 4.

FIGS. 6A and 6B are front and side views, respectively, of a toggle 106 shown in FIG. 4.

FIG. 7 is a schematic diagram of the toggle assembly 104 shown in FIG. 3 mounted inside a first vane portion 102 of an air outlet front blade 101.

FIG. 8 is a schematic cross-sectional view of the vehicle air conditioning vent assembly 100 shown in FIG. 1 along section A-A.

### DETAILED DESCRIPTION

Various specific implementations of the present disclosure will be described below with reference to the accompanying drawings which constitute part of the present disclosure, but would not limit the scope of the present disclosure. It should be understood that although the terms such as “front”, “rear”, “upper”, “lower”, “left”, “right” and so on indicating directions are used in the present disclosure to describe orientations of various illustrative structural parts and elements in the present disclosure, the terms used herein are merely used for ease of description and are determined based on the illustrative orientation shown in the accompanying drawings. Since the embodiments disclosed in the present disclosure can be provided in different orientations, the terms indicating directions are merely illustrative and should not be considered as limitations. In addition, the terms “first”, “second”, etc. used in the present disclosure are merely used to distinguish different objects, instead of indicating that there is any particular sequential relationship between these objects. The term “comprise/include” and derivatives thereof mean inclusion without limitation. Unless otherwise specified and limited, the terms “mounting”, “connecting” and “connection” should be understood broadly. For example, they may be mechanical or electrical connection, internal communication between two elements, or direct connection or indirect connection via an intermediate medium. For those of ordinary skills in the art, the specific meanings of the above terms can be understood according to specific cases. If possible, the same or similar reference signs used in the present disclosure refer to the same components.

In recent years, with the simplification of interior styling, the requirements for a slenderer appearance opening of the vent has gradually become popular, resulting in an increase in the length and thickness of the air outlet front blade. In this case, it becomes more difficult to wrap the toggle structure around the front blade, and the difficulty of adjustment is increased. Because the toggle wraps around the blade, more structure is exposed, and the appearance will be poor from a visual perspective. Since the front blade is mounted on the inner side of the toggle, when the front blade becomes longer, in order to meet the requirements of blade stiffness, the blade needs to be thickened, and the outer contour of the toggle also needs to be enlarged, which will lead to the weakened structure and the movement stagnation of the toggle. Therefore, it is necessary to innovate a vent toggle structure that meets the requirements of interior styling. The toggle structure of the present disclosure can be suitable for longer and thicker air outlet blades, and has a suspended visual effect, so that the appearance of the vent is more attractive.

According to one aspect of the present disclosure, provided is a vehicle air conditioning vent assembly, including an air outlet front blade including a first vane portion and a second vane portion; and a toggle assembly including a toggle bracket and a toggle, wherein the toggle bracket is configured to be mounted in a cavity between the first vane portion and the second vane portion, and the toggle button extends out of the joint portion of the first vane portion and the second vane portion.

According to one aspect of the present disclosure, the toggle assembly further includes a toggle blade, two ends of the toggle blade being each provided with a snap-in portion, the snap-in portion being configured to be in snap-in fit with a receiving portion arranged on one of the first vane portion and the second vane portion, so as to fixedly mount the toggle blade in the air outlet front blade.

According to one aspect of the present disclosure, the snap-in portion includes a plurality of projections, and the receiving portion includes a plurality of holes.

According to one aspect of the present disclosure, the toggle bracket includes a body portion and an extension portion extending at an angle from one end of the body portion.

According to one aspect of the present disclosure, the body portion of the toggle bracket is provided with a track slot, and the extension portion is provided with an insertion slot, wherein the toggle blade is configured to be inserted through the track slot, such that the toggle bracket is mounted in the cavity via the toggle blade and is slidable relative to the air outlet front blade along the toggle blade.

According to one aspect of the present disclosure, the toggle includes a U-shaped snap-in slot and a plug-in portion extending outward from one end of the U-shaped snap-in slot, the plug-in portion being inserted into the insertion slot of the toggle bracket.

According to one aspect of the present disclosure, when the plug-in portion of the toggle is inserted into the insertion slot of the toggle bracket, the front end of one of the first vane portion and the second vane portion is snapped in the U-shaped snap-in slot of the toggle.

According to one aspect of the present disclosure, the track slot of the toggle bracket is hollow, openings at both ends of the track slot are shaped to fit the section of the toggle blade, and the insertion slot of the toggle bracket is shaped to fit the plug-in portion of the toggle.

According to one aspect of the present disclosure, the toggle assembly further includes a toggle damper provided between the toggle bracket and the toggle blade.

According to one aspect of the present disclosure, the toggle assembly further includes a fork bracket configured to be fixed to the toggle bracket via a snap-in structure arranged on the fork bracket.

According to one aspect of the present disclosure, the toggle assembly further includes a fork, one end of the fork is fixed to the fork bracket and the other end is connected to a rear blade assembly, so that the toggle drives the rear blade to rotate left and right when sliding relative to the air outlet front blade.

According to one aspect of the present disclosure, the toggle is configured to be toggled up and down so as to drive the air outlet front blade to rotate up and down.

Some of the additional aspects and advantages of the present disclosure will be set forth in the following description, and some will become apparent from the following description, or be learned by practice of the present disclosure.

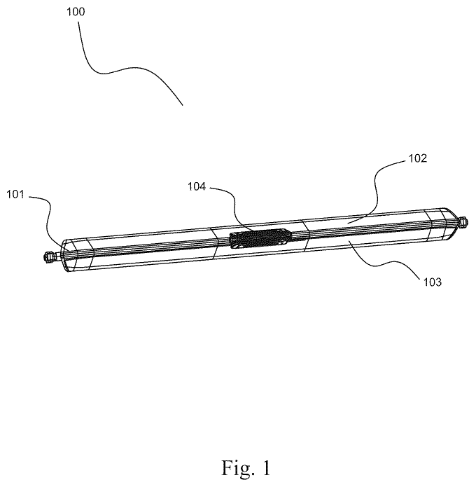

FIG. 1 is a structural schematic diagram of a vehicle air conditioning vent assembly 100 according to an aspect of the present disclosure.

As shown in FIG. 1, the vehicle air conditioning vent assembly 100 includes an air outlet front blade 101 and a toggle assembly 104. The air outlet front blade 101 includes a first vane portion 102 and a second vane portion 103. The first vane portion 102 and the second vane portion 103 are combined to form the air outlet front blade 101. As shown in FIG. 1, the toggle assembly 104 is mounted on the front blade 101 in a “suspended” manner instead of being mounted on the front blade 101 in a wrapping manner. By toggling the toggle assembly 104 up and down, the toggle assembly 104 can drive the front blade 101 to rotate together in up and down directions, thus adjusting the airflow direction of the vent in the up and down directions. By toggling the toggle assembly 104 left and right, the toggle assembly 104 can slide left and right to some extent relative to the front blade 101, and at the same time, a fork (which will be described in detail below) of the toggle assembly that extends from the rear joint of the air outlet front blade 101 can drive an air outlet rear blade (not shown) to rotate in left and right directions, so as to adjust the airflow direction of the vent in the left and right directions.

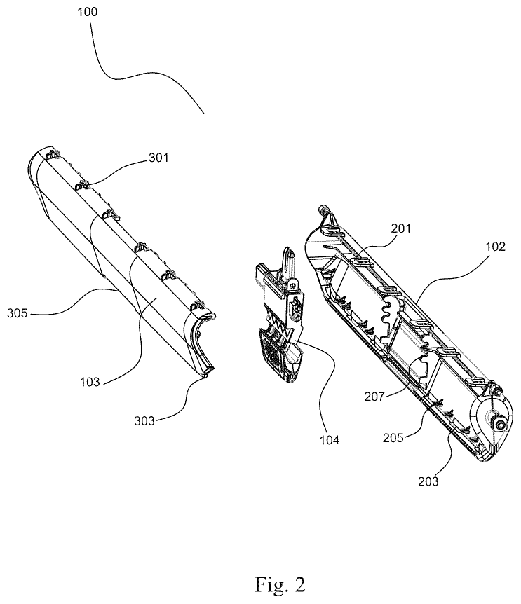

FIG. 2 is an exploded schematic diagram of the vehicle air conditioning vent assembly 100 shown in FIG. 1.

As shown in FIG. 2, a part of the toggle assembly 104 is located in a cavity formed between the first vane portion 102 and the second vane portion 103 of the air outlet front blade 101, the toggle of the toggle assembly 104 partially extends from the front joint of the air outlet front blade 101 and is snapped at the front joint, thus visually creating a “suspended” effect, and the fork of the toggle assembly 104 extends from the rear joint of the air outlet front blade 101. As shown in FIG. 2, a plurality of buckles 201 are arranged on the outer side of the edge of the rear end of the first vane portion 102, the front end of the first vane portion 102 is arc-shaped, a plurality of positioning recesses 203 are arranged on the inner side of the edge of the front end of the first vane portion 102, and a plurality of limiting protrusions 205 are arranged between the plurality of positioning recesses 203. Correspondingly, a plurality of snap-in protrusions 301 are arranged on the outer side of the edge of the rear end of the second vane portion 103, and a plurality of positioning protuberances 303 are arranged at the edge of the front end of the second vane portion 103. In the process of combining the first vane portion 102 and the second vane portion 103 together, firstly, the plurality of positioning protuberances 303 at the edge of the front end of the second vane portion 103 are inserted into the corresponding positioning recesses 203 on the inner side of the edge of the front end of the first vane portion 102, so that the front end of the second vane portion 103 is snapped between the plurality of limiting protrusions 205 of the first vane portion 102 and the edge of the arc-shaped front end of the first vane portion 102, to engage the front ends of the first vane portion 102 and the second vane portion 103 with each other. Next, the rear end of the second vane portion 103 is moved toward the rear end of the first vane portion 102, until the plurality of snap-in protrusions 301 arranged on the outer side of the edge of the rear end of the second vane portion 103 are snapped into the plurality of buckles 201 arranged on the outer side of the edge of the rear end of the first vane portion 102, to engage the rear ends of the first vane portion 102 and the second vane portion 103 with each other. At this time, the first vane portion 102 and the second vane portion 103 are fixedly mounted together, thus forming the air outlet front blade 101. Those skilled in the art should appreciate that the aforementioned mounting process is only an example, and the first vane portion 102 and the second vane portion 103 may also be mounted together to form the air outlet front blade 101 by other coupling methods.

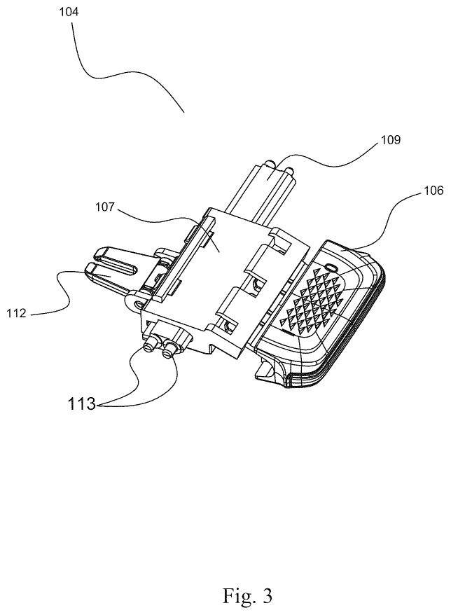

FIG. 3 is a structural schematic diagram of the assembled toggle assembly 104 shown in FIG. 2.

As shown in FIG. 3, according to one aspect of the present disclosure, the toggle assembly 104 mounted in the cavity formed between the first vane portion 102 and the second vane portion 103 in FIG. 2 mainly includes a toggle bracket 107, and a toggle 106, a toggle blade 109 and a fork 112 that are fixedly mounted on the toggle bracket 107. The toggle bracket 107, the toggle 106 and the fork 112 can slide along the toggle blade 109. Two ends of the toggle blade 109 are each provided with a pair of projections 113, and the toggle blade 109 is fixedly mounted in the cavity between the first vane portion 102 and the second vane portion 103 by mounting the projections 113 at both ends of the toggle blade into the corresponding four receiving portions 207 (shown as Omega-shaped holes) arranged on the inner surface of the first vane portion 102 shown in FIG. 2. In this case, the toggle bracket 107, the toggle 106 and the fork 112 can slide along the toggle blade 109 relative to the air outlet front blade 101 composed of the first vane portion 102 and the second vane portion 103. The various components of the toggle assembly 104 will be described in more detail below.

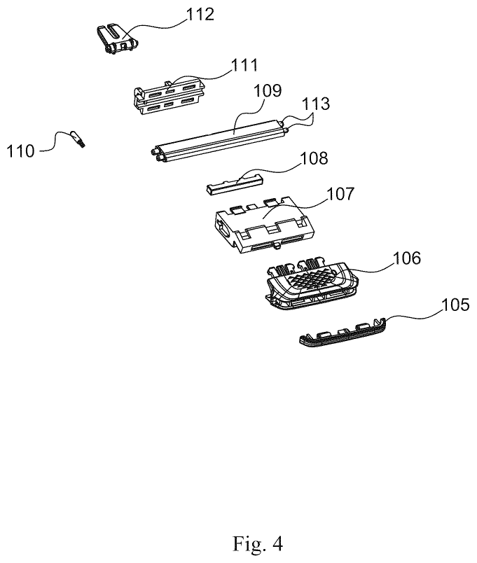

FIG. 4 is a structural exploded schematic diagram of the toggle assembly 104 shown in FIG. 3.

As shown in FIG. 4, according to one aspect of the present disclosure, the toggle assembly 104 includes: a toggle trim strip 105, the toggle 106, the toggle bracket 107, a toggle damper 108, the toggle blade 109, a ball plunger 110, a fork bracket 111, and the fork 112. In the assembly process of the toggle assembly 104, firstly, the toggle damper 108 is mounted on the toggle bracket 107, the toggle blade 109 is inserted into a track slot (which will be described in detail below) on the side of the toggle bracket 107, then the ball plunger 110 is mounted on the toggle blade 109, then the fork bracket 111 is mounted on the toggle bracket 107 in a snapping manner, and then the fork 112 is mounted on the fork bracket 111, thereby forming a temporary assembly. Four Omega-shaped holes 207 are formed on the inner surface of the first vane portion 102 of the air outlet front blade 101, and the temporary assembly is mounted on the first vane portion 102 by mounting the four projections 113 arranged on two sides of the toggle blade 109 of the temporary assembly into the four Omega-shaped holes. Those skilled in the art should appreciate that the Omega-shaped holes may also be provided on the second vane portion 103, and the temporary assembly may be mounted on the first vane portion 102 or the second vane portion 103 in other manners instead of being only limited to the mating of the holes and the projections. After the temporary assembly is mounted, the toggle 106 is mounted on the toggle bracket 107, then the toggle trim strip 105 is mounted on the toggle 106, and finally, the second vane portion 103 and the first vane portion 102 of the air outlet front blade 101 are mounted together, thus forming the complete front blade 101 and the toggle assembly 104 mounted thereto shown in FIG. 1. In this case, the toggle bracket 107 is located in the cavity formed between the second vane portion 103 and the first vane portion 102 of the air outlet front blade 101. As shown in FIG. 4, in order to improve the operation feel of adjusting the air outlet blade in the up and down directions, dampers 114 may be sleeved on two sides of a shaft of the front blade 101, the front blade 101 is mounted to the front end of an air outlet housing (not shown) via a front blade shaft, and a rear blade assembly (not shown) is mounted to the rear end of the air outlet housing via a rear blade bracket (not shown).

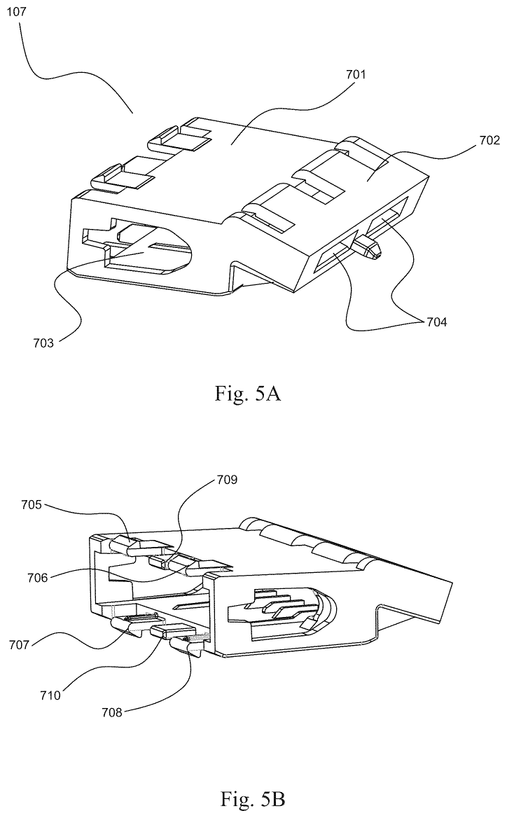

FIGS. 5A and 5B are a structural schematic side view and a structural schematic rear view, respectively, of the toggle bracket 107 shown in FIG. 4.

As shown in FIGS. 5A and 5B, according to one aspect of the present disclosure, the toggle bracket 107 is provided with a rectangular body portion 701 and an extension portion 702 extending at an angle from the front end of the body portion 701, a track slot 703 is formed in the body portion 701, and an insertion slot 704 is formed in the extension portion 702. The track slot 703 is hollow, openings at both ends of the track slot are shaped to fit the end faces of the toggle blade 109, and the size of the openings at both ends of the track slot 703 is slightly greater than the cross-sectional size of the toggle blade 109, so that when the toggle blade 109 is inserted into the track slot 703, the track slot 703 can allow the toggle bracket 107 to slide left and right relative to the toggle blade 109. As shown in FIGS. 5A and 5B, the insertion slot 704 is composed of two slots for accommodating the insertion of the toggle 106. Those skilled in the art should appreciate that the track slot 703 and the insertion slot 704 of the toggle bracket 107 may also have other shapes as long as the functions of mounting the toggle blade 109 and the toggle 106 can be realized. As shown in FIG. 5B, the rear end of the toggle bracket 107 is provided with two pairs of snap-in clastic pieces 705, 706, 707, 708, and two positioning pins 709, 710 arranged between the two pairs of snap-in elastic pieces. The two pairs of snap-in clastic pieces 705, 706, 707, 708 and the positioning pins 709, 710 are respectively used to mate with the snap-in structure and a positioning structure arranged on the fork bracket 111 shown in FIG. 4, so as to fixedly mount the fork bracket 111 on the toggle bracket 107. Those skilled in the art should appreciate that the fork bracket 111 and the toggle bracket 107 may also be connected to each other in other manners.

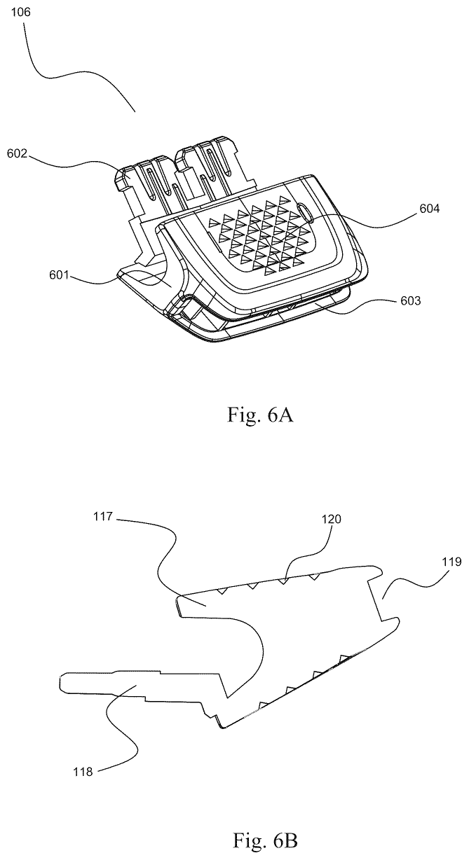

FIGS. 6A and 6B are front and side views, respectively, of the toggle 106 shown in FIG. 4.

As shown in FIGS. 6A and 6B, according to one aspect of the present disclosure, the toggle 106 is provided with a U-shaped snap-in slot 601 and a plug-in portion 602 extending outward from one end of the U-shaped snap-in slot 601. The plug-in portion 602 is configured to be inserted into the insertion slot 704 of the toggle bracket 107 shown in FIGS. 5A and 5B, so as to mount the toggle 106 on the toggle bracket 107. When the toggle 106 is inserted into the insertion slot 704, the front end of the first vane portion 102 of the air outlet front blade 101 is snapped in the U-shaped snap-in slot 601 of the toggle 106, thereby fixing the toggle 106 to the front blade 101 in a “suspended” manner. As shown in FIGS. 6A and 6B, the front end of the toggle 106 is further provided with a groove 603 for mounting the toggle trim strip 105. The upper and lower surfaces of the toggle 106 are further provided with anti-slip structures 604 for increasing the friction when a user holds the toggle 106, so that the user can conveniently adjust the toggle in the up and down directions and in the left and right directions. Those skilled in the art should appreciate that the anti-slip structure 604 of the toggle 106 may have other shapes, as long as the function of increasing the friction when the user holds the toggle can be realized.

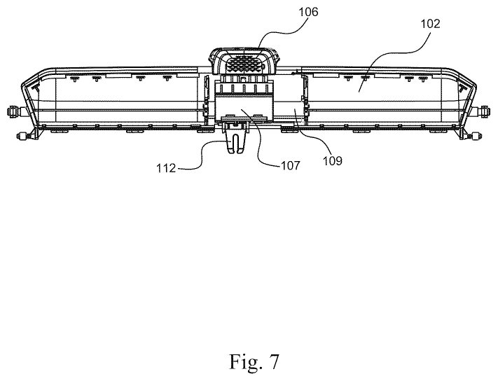

FIG. 7 is a schematic diagram of the toggle assembly 104 shown in FIG. 3 mounted inside the first vane portion 102 of the air outlet front blade 101.

As shown in FIG. 7, according to one aspect of the present disclosure, the toggle assembly 104 is mounted inside the first vane portion 102 of the air outlet front blade 101 by mounting the projections arranged at both ends of the toggle blade 109 into the four Omega-shaped holes formed inside the first vane portion 102 of the air outlet front blade 101. In this case, the toggle 106 of the toggle assembly 104 protrudes from a slot portion 305 arranged at the center of the front end of the second vane portion 103 shown in FIG. 2, so as to be snapped in the front end of the first vane portion 102 in a “suspended” manner, and the toggle 106 and the toggle bracket 107 can slide left and right to some extent relative to the fixedly mounted toggle blade 109, so as to drive the fork 112 and the rear blade assembly connected thereto to move left and right together, thereby implementing the left-and-right rotation of the rear blade. Those skilled in the art should appreciate that according to specific design requirements, the toggle 106 may also be snapped in the front end of the second vane portion 103 in a “suspended” manner.

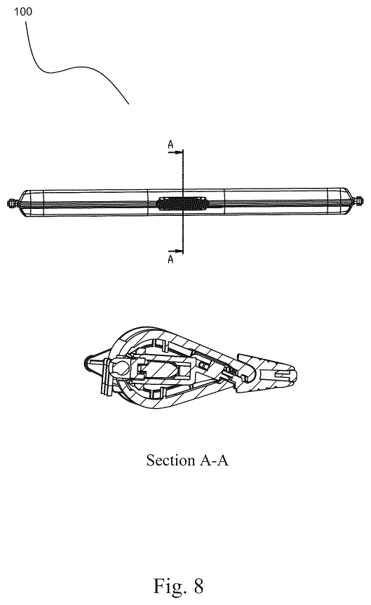

FIG. 8 is a schematic cross-sectional view of the vehicle air conditioning vent assembly 100 shown in FIG. 1 along section A-A.

As shown in FIG. 8, according to one aspect of the present disclosure, the first vane portion 102 and the second vane portion 103 of the air outlet front blade 101 are of arc-shaped structures which are shaped to fit with each other, so that when the second vane portion 103 is mounted to the first vane portion 102, a cavity can be formed between the first vane portion and the second vane portion for accommodating the toggle bracket 107, the toggle blade 109 and other components of the toggle assembly 104. As shown in FIGS. 8, 5A and 5B, the body portion 701 and the extension portion 702 of the toggle bracket 107 are at an angle, that is, the extension portion 702 extends at an angle relative to the body portion 701. This angle enables the extension portion 702 of the toggle bracket 107 to be approximately parallel to the corresponding surface of the first vane portion 102. As shown in FIG. 8, the toggle 106 extends out of the joint portion of the first vane portion 102 and the second vane portion 103. Since only the U-shaped snap-in slot of the toggle 106 is in contact with the front end of the front blade, and most parts of the front blade are not blocked by other structures, the visual effect that the toggle is suspended above the blade is generated, and the aesthetic feeling of the vent is increased. Those skilled in the art should appreciate that the toggle 106 may be integrally formed with the toggle bracket 107, as long as the functions of enabling them to be mounted to the front blade and having a suspended visual effect can be realized.

The toggle structure of the vehicle air conditioning vent of the present disclosure has the following advantages.

Firstly, in the prior art, the toggle generally wraps around the front blade, resulting in that more structure of the toggle itself is exposed, and the appearance will be poor from a visual perspective. The structure of the toggle assembly in the present disclosure is hidden in the front blade with only a few parts of the toggle making contact with the front blade, and the structure of the toggle itself is less exposed, thus having a suspended effect visually, and increasing the aesthetics of the vent.

Secondly, in the prior art, since the front blade is mounted on the inner side of the toggle, when the front blade becomes longer, in order to meet the requirements of blade stiffness, the blade needs to be thickened, and the outer contour of the toggle also needs to be enlarged, which will lead to the weakened structure of the toggle and the resulting movement stagnation of the toggle. The present disclosure adopts the design that the toggle assembly is built in the blade, and the toggle assembly does not need to wrap around the front blade, thus avoiding the problems of the toggle assembly becoming larger and the structure becoming weaker due to the thickening of the blade.

Thirdly, the toggle assembly adopted in the present disclosure can meet the stiffness requirements of the blade after the blade becomes longer and thicker, and the toggle assembly is also more in line with customers and market trends.

Although the present disclosure is described in conjunction with the examples of embodiments outlined above, various alternatives, modifications, variations, improvements, and/or substantial equivalents that are known or current or to be anticipated before long may be obvious to those of at least ordinary skill in the art. In addition, the technical effects and/or technical problems described in the present disclosure are illustrative rather than restrictive. Therefore, the disclosed description in the present disclosure may be used to solve other technical problems and have other technical effects and/or may solve other technical problems. Accordingly, the examples of the embodiments of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or basic equivalents.

What is claimed is:

1. A vehicle air conditioning vent assembly (100), comprising:
an air outlet front blade (101), the air outlet front blade (101) comprising a first vane portion (102) and a second vane portion (103); and
a toggle assembly (104), the toggle assembly (104) comprising a toggle bracket (107) and a toggle (106), the toggle bracket (107) being configured to be mounted in a cavity between the first vane portion (102) and the second vane portion (103), and the toggle (106) extending out of a joint portion of the first vane portion (102) and the second vane portion (103).

2. The vehicle air conditioning vent assembly (100) according to claim 1, wherein:
the toggle assembly (104) further comprises a toggle blade (109), two ends of the toggle blade (109) being each provided with a snap-in portion (113), the snap-in portion (113) being configured to be in snap-in fit with a receiving portion (207) arranged on one of the first vane portion (102) and the second vane portion (103), so as to fixedly mount the toggle blade (109) in the air outlet front blade (101).

3. The vehicle air conditioning vent assembly (100) according to claim 2, wherein:
the snap-in portion (113) comprises a plurality of projections, and the receiving portion (207) comprises a plurality of holes.

4. The vehicle air conditioning vent assembly (100) according to claim 2, wherein:
the toggle bracket (107) comprises a body portion (701) and an extension portion (702) extending at an angle from one end of the body portion (701).

5. The vehicle air conditioning vent assembly (100) according to claim 4, wherein:
the body portion (701) of the toggle bracket (107) is provided with a track slot (703), and the extension portion (702) is provided with an insertion slot (704), wherein the toggle blade (109) is configured to be inserted through the track slot (703), such that the toggle bracket (107) is mounted in the cavity via the toggle blade (109) and is slidable relative to the air outlet front blade (101) along the toggle blade (109).

6. The vehicle air conditioning vent assembly (100) according to claim 5, wherein:
the toggle (106) comprises a U-shaped snap-in slot (601) and a plug-in portion (602) extending outward from one end of the U-shaped snap-in slot (601), the plug-in portion (602) being inserted into the insertion slot (704) of the toggle bracket (107).

7. The vehicle air conditioning vent assembly (100) according to claim 6, wherein:
when the plug-in portion (602) of the toggle (106) is inserted into the insertion slot (704) of the toggle bracket (107), the front end of one of the first vane portion (102) and the second vane portion (103) is snapped in the U-shaped snap-in slot (601) of the toggle (106).

8. The vehicle air conditioning vent assembly (100) according to claim 6, wherein:
the track slot (703) of the toggle bracket (107) is hollow, openings at both ends of the track slot (703) are shaped to fit a section of the toggle blade (109), and the insertion slot (704) of the toggle bracket (107) is shaped to fit the plug-in portion (602) of the toggle (106).

9. The vehicle air conditioning vent assembly (100) according to claim 2, wherein:
the toggle assembly (104) further comprises a toggle damper (108), the toggle damper (108) being provided between the toggle bracket (107) and the toggle blade (109).

10. The vehicle air conditioning vent assembly (100) according to claim 1, wherein:
the toggle assembly (104) further comprises a fork bracket (111), the fork bracket (111) being configured to be fixed to the toggle bracket (107) via a snap-in structure arranged on the fork bracket (111).

11. The vehicle air conditioning vent assembly (100) according to claim 10, wherein:
the toggle assembly (104) further comprises a fork (112), one end of the fork (112) is fixed to the fork bracket (111) and the other end is connected to a rear blade assembly, so that the toggle (106) drives the rear blade to rotate left and right when sliding relative to the air outlet front blade (101).

12. The vehicle air conditioning vent assembly (100) according to claim 1, wherein:
the toggle (106) is configured to be toggled up and down so as to drive the air outlet front blade (101) to rotate up and down.
